(19) United States
(12) Patent Application Publication
(10) Pub. No.: US 2018/0265147 A1
(43) Pub. Date: Sep. 20, 2018

(54) BI-FOLD TRAILER SYSTEM AND METHOD

(71) Applicants: Gabor Budahazi, Scottsdale, AZ (US); Michael Kiss, Phoenix, AZ (US)

(72) Inventors: Gabor Budahazi, Scottsdale, AZ (US); Michael Kiss, Phoenix, AZ (US)

(21) Appl. No.: 15/922,801

(22) Filed: Mar. 15, 2018

Related U.S. Application Data
(60) Provisional application No. 62/471,686, filed on Mar. 15, 2017.

(51) Int. Cl. B62D 63/06; B25H 1/04; B25H 1/12

(52) U.S. Cl. CPC B62D 63/061; B62D 63/062; B60G 11/27; B25H 1/12; B25H 1/04

(57) ABSTRACT

A bi-fold trailer system includes a trailer-chassis, at least two wheel assemblies rotatably coupled to said trailer-chassis, and a plurality of casters coupled to the trailer-chassis. The trailer-chassis includes a frame, an extension, and a yoke. The yoke is removably coupleable to the extension of the trailer-chassis. The bi-fold trailer system is removably coupleable to a vehicle. The frame of the trailer-chassis includes a left-side-frame and a right-side-frame, with the left-side-frame and the right-side-frame hingedly coupled such that the left-side-frame and the right-side-frame are rotatable outward from each other into an open position when removed from the vehicle.

### CROSS-REFERENCE TO RELATED APPLICATION(S)

The present application is related to and claims priority to U.S. Provisional Patent Application No. 62/471,686 filed Mar. 15, 2017, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of automobiles of existing art and more specifically relates to trailering and hauling.

### RELATED ART

Generally, a trailer is an unpowered vehicle that is towable by a powered vehicle. It is commonly used for the transport of goods and materials, providing a mobile workstation, or for recreational use. Sometimes trailers can include recreational vehicles, travel trailers, or mobile homes with living facilities, where people can camp.

In earlier days, many such vehicles were towable trailers. Trailers can be towed by a vehicle in many ways. A trailer can be a bumper pull (i.e., trailer hitch mounted near the rear bumper of the vehicle) or may be mounted in the bed or rear area of a pickup truck, tractor or semi-truck. Trailers come in many shapes and sizes and can be used for working functions such as mobile work stations.

One such limitation with standard trailers is that when used as a mobile platform for work, items must be unloaded and/or a user must enter the trailer to access the materials within. Therefore, a suitable solution is desired.

U.S. Pat. No. 3,582,131 to Alan J. Brown relates to a collapsible trailer. The described collapsible trailer includes a rigid walled, collapsible trailer housing in which the sidewalls fold inwardly to lower the roof to meet a base portion, the assembly being sectioned along a transverse vertical plane for the further folding of one section to overlie the other section.

### SUMMARY OF THE INVENTION

In view of the foregoing disadvantages inherent in the known trailering and hauling art, the present disclosure provides a novel bi-fold trailer system and method. The general purpose of the present disclosure, which will be described subsequently in greater detail, is to provide an efficient bi-fold trailer system and method.

A bi-fold trailer system is disclosed herein. Preferably, the bi-fold trailer system includes a trailer-chassis, at least two wheel assemblies rotatably coupled to said trailer-chassis, and a plurality of casters coupled to the trailer-chassis nearest at least four corners of the trailer-chassis. The trailer-chassis itself includes a frame, an extension located on a front-end of the trailer-chassis, and a yoke. The extension is slideable within the trailer-chassis, in the preferred embodiment.

The yoke is removably coupleable to the extension of the trailer-chassis on the front-end. The bi-fold trailer system is removably coupleable to a vehicle, with the yoke being configured to be coupleable to the vehicle via a bumper-pull style hitch. Also, the yoke is removable from the trailer-chassis via one or more yoke pins.

The frame of the trailer-chassis includes a left-side-frame and a right-side-frame, with the left-side-frame and the right-side-frame hingedly coupled at a rear-end of the trailer-chassis such that the left-side-frame and the right-side-frame are rotatable outward from each other into an open position when removed from the vehicle.

Preferably, the trailer-chassis includes a tool-box assembly and the at least two wheel assemblies that are rotatable via an air-bag system, with the air-bag system also acting as the suspension of the trailer-chassis.

According to another embodiment, a method of using a bi-fold trailer system is also disclosed herein. The method of using a bi-fold trailer system includes a first step, providing a bi-fold trailer system; a second step, coupling the bi-fold trailer system to a vehicle; a third step, moving the bi-fold trailer system via the vehicle; a fourth step, decoupling the bi-fold trailer system from the vehicle, a fifth step; removing a yoke from the bi-fold trailer system, a sixth step, expanding a left-side-frame and a right-side-frame of the bi-fold trailer system outward from each other; a seventh step, contracting the left-side-frame and the right-side frame together; an eighth step, replacing the yoke to the bi-fold trailer system; and a ninth-step, coupling the bi-fold trailer system to the vehicle (or alternatively, a second/alternate vehicle).

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a bi-fold trailer system and method, constructed and operative according to the teachings of the present disclosure.

FIG. 1A is a perspective view of the bi-fold trailer system during an ‘in-use’ condition, according to an embodiment of the disclosure.

FIG. 1B is an additional perspective view of the bi-fold trailer system during an ‘in-use’ condition, according to an embodiment of the disclosure.

FIG. 2 is a perspective view of the bi-fold trailer system of FIGS. 1A and 1B, according to an embodiment of the present disclosure.

FIG. 3A is a perspective view of the bi-fold trailer system of FIGS. 1A and 1B in a fully open condition, according to an embodiment of the present disclosure.

FIG. 3B is a perspective view of the bi-fold trailer system of FIGS. 1A and 1B in a partially open condition, according to an embodiment of the present disclosure.

FIG. 4A is a side view of the bi-fold trailer system of FIGS. 1A and 1B showing a wheel assembly in a downward position, according to an embodiment of the present disclosure.

FIG. 4B is a side view of the bi-fold trailer system of FIGS. 1A and 1B showing a wheel assembly in an upward position, according to an embodiment of the present disclosure.

FIG. 5 is a flow diagram illustrating a method of using the bi-fold trailer system, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a trailering and hauling and more particularly to a bi-fold trailer system and method as used to improve the versatility and usability of a towable trailer unit by providing a unit that allows a user to gain the benefits of a roll-off trailer without the need of special tools nor equipment to provide a mobile work station.

Generally, the purpose of a bi-fold trailer system may be to be a portable work shop including storage for tools and equipment, and materials as well as a work surface and/or counter top. The bi-fold trailer system's primary users would be people who engage in racing automobiles, trucks, bicycles, motorcycles, go-karts, off-road vehicles, as well as recreational vehicles of all sorts. The design allows users to transport their work shop from home to their destination giving them access to all the tools and work areas necessary for repairs and maintenance.

The present invention looks very similar to an enclosed trailer; however it opens from the front to a 90 or 180 degree angle creating a workspace which may house tools, equipment and/or storage. When the present invention is closed it is a sealed box that is indistinguishable from a traditional enclosed trailer. When open the bi-fold trailer system is essentially a full work bench with tools and storage. The bi-fold trailer may utilize a wide variety of materials or combinations thereof (e.g., steel, aluminum, HDPE, fiberglass, etc.) and may also include prefabricated parts and components (e.g., wheels, trailer accessories, tool boxes, etc.).

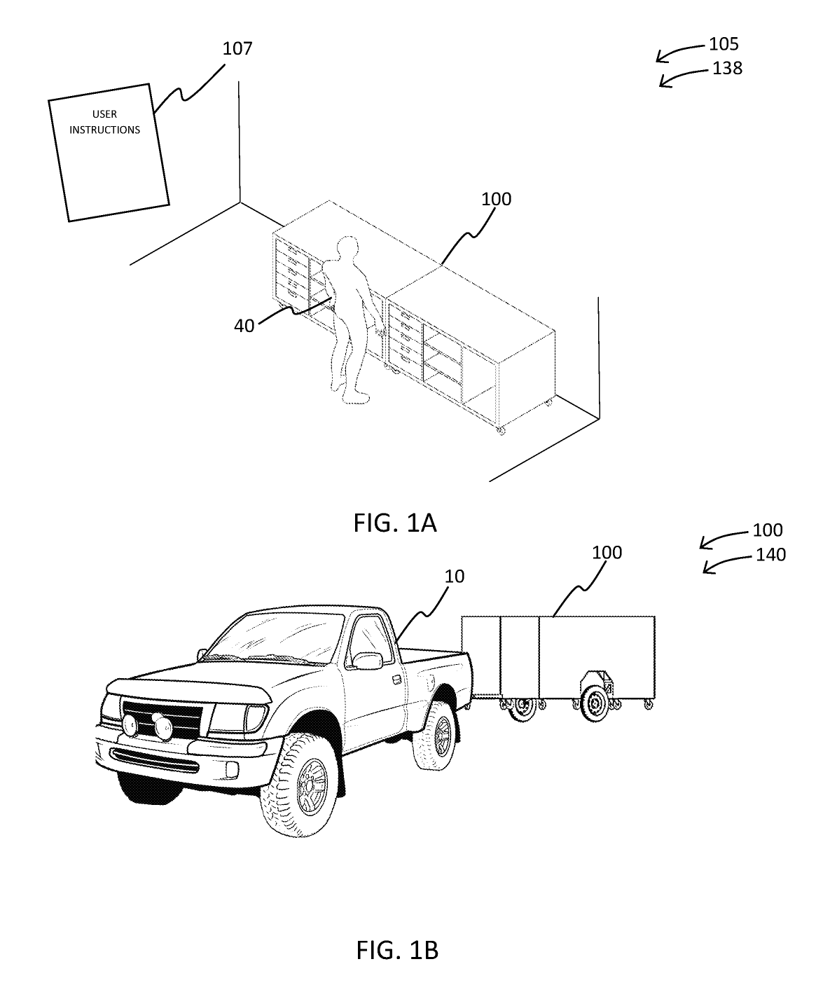

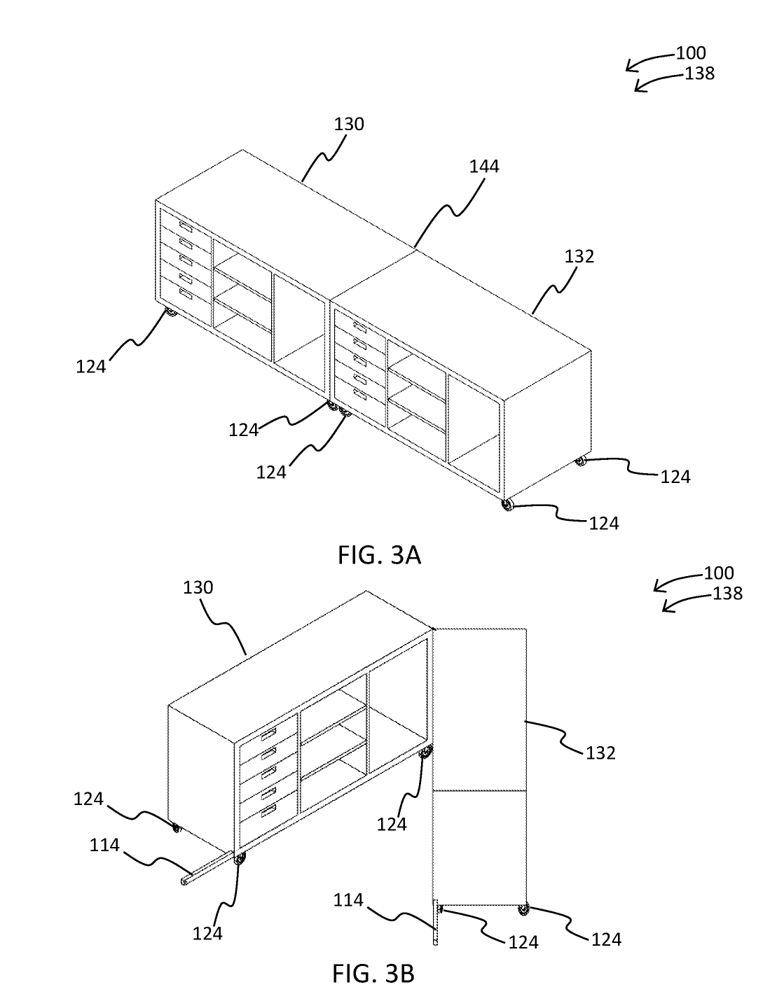

Referring now more specifically to the drawings by numerals of reference, there is shown in FIGS. 1A-4B, various views of a bi-fold trailer system 100.

FIGS. 1A and 1B show a bi-fold trailer system 100 during an ‘in-use’ condition 50, according to an embodiment of the present disclosure. Here, the bi-fold trailer system 100 may be beneficial for use by a user 40 to provide a towable and mobile workstation without the need load and unload toolboxes, workbenches, etc. from the trailer.

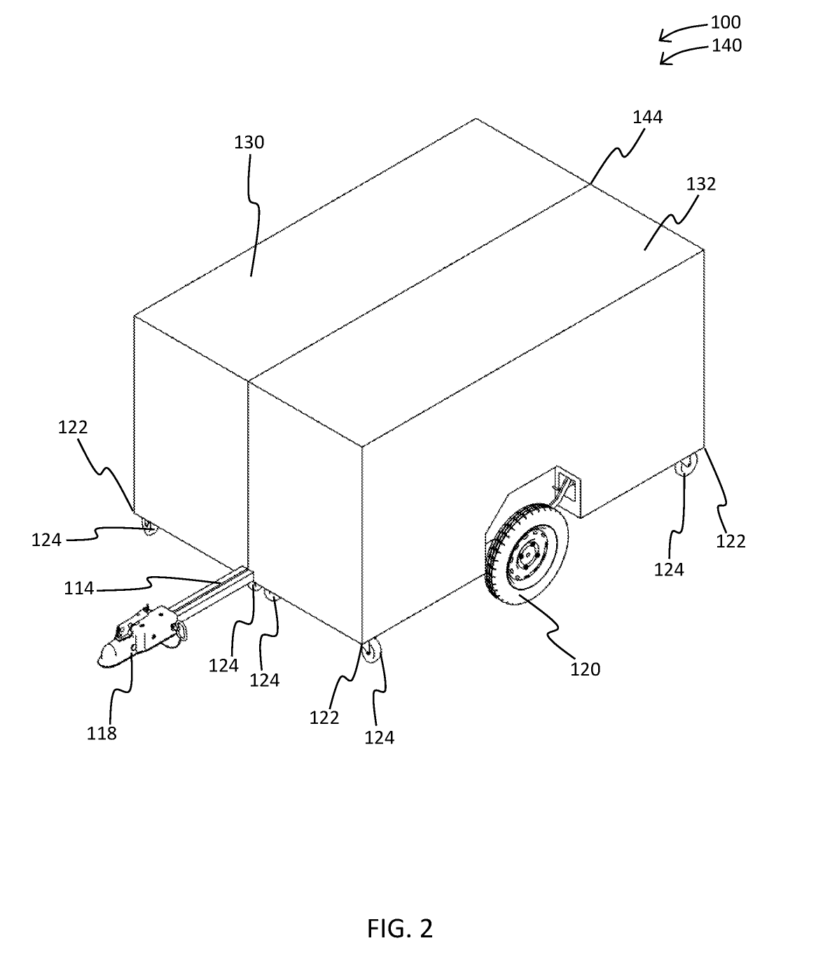

As illustrated in FIGS. 1A-4B, bi-fold trailer system 100 may include trailer-chassis 110, at least two wheel assemblies 120 rotatably coupleable to trailer-chassis 110, and plurality of casters 124 coupled to trailer-chassis 110 nearest at least for corners 122 of trailer-chassis 110. Bi-fold trailer system 100 may further include tool-box assembly 144, where tool-box assembly 144 may be removable from trailer-chassis 110. Tool-box assembly 144 may be removably coupleable via fasteners, pins, clamps, or any other suitable means. Bi-fold trailer system 100 may be removably coupleable to vehicle 10, and therefore towable in closed position 140, as shown in FIG. 2. Those with ordinary skill in the art will now appreciate that upon reading this specification and by their understanding the art of trailers and land vehicles as described herein, methods of using a bi-fold trailer system will be understood by those knowledgeable in such art.

Trailer-chassis 110 may include frame 112, extension 114 located on front-end 116 of trailer-chassis 110, and yoke 118. Yoke 118 may removably coupleable to extension 114 of trailer-chassis 110 on front-end 116, and yoke 118 may be removable and replaceable via one or more yoke-pin(s) or any other suitable fasteners. Additionally, yoke 118 may be coupleable to a variety of standard hitches, including, but not limited to a bumper-pull hitch, a fifth-wheel hitch, a goose-neck hitch, and/or a ring hitch.

Frame 112 of trailer-chassis 110 may include left-side-frame 130 and right-side-frame 132, with left-side-frame 130 and right-side-frame 132 hingedly coupled at a rear-end of trailer-chassis 110 such that left-side-frame 130 and right-side-frame 132 are rotatable outward from each other into open position 138 when removed from vehicle 10.

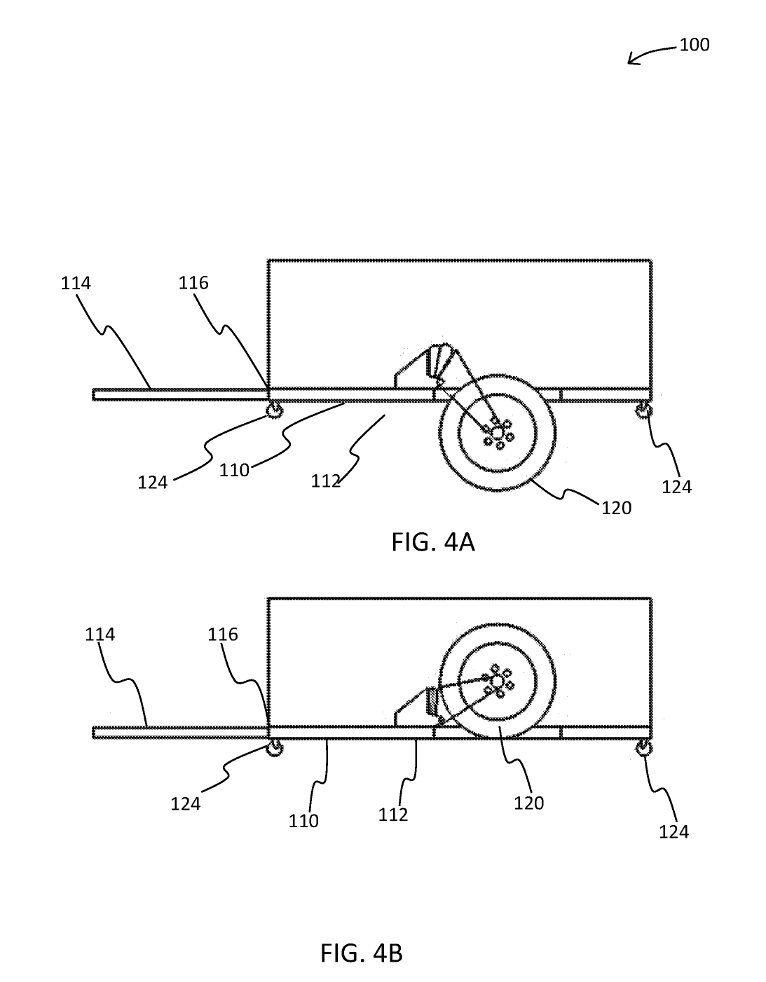

Referring now more specifically to FIGS. 4A and 4B, at least two wheel assemblies 120 may be rotatable via different mechanical or manual system. The mechanical systems may include, but not be limited by, an air-bag system, a hydraulic system, electric actuators, or a combination thereof. Manual systems may include user 40 lifting and/or lowering at least two wheel assemblies 120 by pressing downward, lifting upward, or other suitable means. Additionally, least two wheel assemblies 120 may also include a leaf-spring suspension, an air-bag suspension, or any other suitable suspension means.

Extension 114 may be removable from trailer-chassis 110, in embodiments. Other embodiments may include extension 114 that may be slidable within trailer-chassis 110, and/or extension 114 may be rotatable upward in relation to trailer-chassis 110 to reduce the overall length of bi-fold trailer system 100. Upon reading this specification, it should be appreciated that, under appropriate circumstances, considering such issues as user preferences, design preference, structural requirements, marketing preferences, cost, available materials, technological advances, etc., other bi-fold trailer system arrangements such as, for example, height, length, materials, etc., may be sufficient.

According to one embodiment, bi-fold trailer system 100 may be arranged as a kit 105. In particular, bi-fold trailer system 100 may further include a set of instructions 107. Instructions 107 may detail functional relationships in relation to the structure of the bi-fold trailer system 100 such that the bi-fold trailer system 100 can be used, maintained, or the like, in a preferred manner.

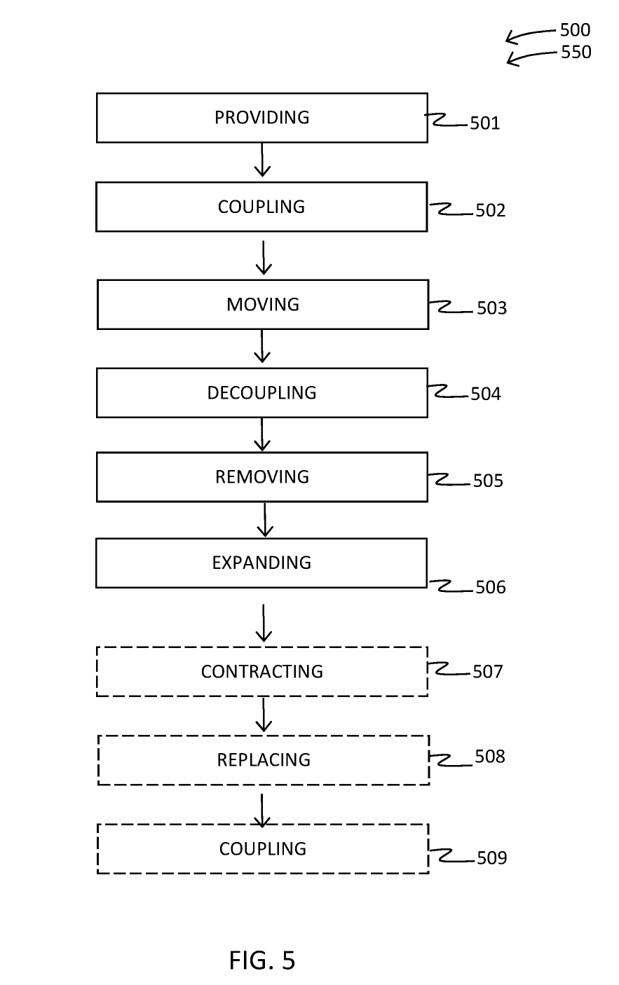

FIG. 5 is a flow diagram illustrating method of using a bi-fold trailer system 500, according to an embodiment of the present disclosure. In particular method of using a bi-fold trailer system 500 may include one or more components or features of bi-fold trailer system 100 as described above. As illustrated, method of using a bi-fold trailer system 500 may include the steps of: step one 501, providing a bi-fold trailer system 100; step two 502, coupling bi-fold trailer system 100 to vehicle 10; step three 503, moving bi-fold trailer system 100 via vehicle 10; step four 504, decoupling bi-fold trailer system 100 from vehicle 10; step five 505, removing yoke 118 from bi-fold trailer system 100; step six 506, expanding left-side-frame 130 and right-side-frame 132 of bi-fold trailer system 100 outward from each other; step seven 507, contracting left-side-frame 130 and right-side frame 132 together; step eight 508, replacing yoke 118 to bi-fold trailer system 100; and step nine 509, coupling bi-fold trailer system 100 to vehicle 10, and alternatively, a second-vehicle.

It should be noted that step seven 507, step eight 508, and step nine 509 are an optional step and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods of using a bi-fold trailer system are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A bi-fold trailer system, the bi-fold trailer system comprising:
a trailer-chassis, said trailer-chassis comprising a frame, an extension located on a front-end of said trailer-chassis, and a yoke;
at least two wheel assemblies rotatably coupled to said trailer-chassis;
a plurality of casters coupled to said trailer-chassis nearest at least at four corners of said trailer-chassis;
wherein said yoke is removably coupleable to said extension of said trailer-chassis on said front-end;
wherein said bi-fold trailer system is removably coupleable to a vehicle; and
wherein said frame of said trailer-chassis includes a left-side-frame and a right-side-frame, with said left-side-frame and said right-side-frame hingedly coupled at a rear-end of said trailer-chassis such that said left-side-frame and said right-side-frame are rotatable outward from each other into an open position when removed from said vehicle.

2. The bi-fold trailer system of claim 1, wherein said trailer-chassis includes a tool-box assembly.

3. The bi-fold trailer system of claim 1, wherein said at least two wheel assemblies are rotatable via an air-bag system.

4. The bi-fold trailer system of claim 1, wherein said at least two wheel assemblies are rotatable via a hydraulic system.

5. The bi-fold trailer system of claim 1, wherein said at least two wheel assemblies are rotatable via an electric actuator.

6. The bi-fold trailer system of claim 1, wherein said yoke is removable and replaceable via a yoke-pin.

7. The bi-fold trailer system of claim 1, wherein said at least two wheel assemblies include a leaf-spring suspension.

8. The bi-fold trailer system of claim 1, wherein said at least two wheel assemblies include an air-bag suspension.

9. The bi-fold trailer system of claim 2, wherein said tool-box assembly is removable from said trailer-chassis.

10. The bi-fold trailer system of claim 3, wherein said tool-box assembly is coupleable to said trailer-chassis via fasteners.

11. The bi-fold trailer system of claim 1, wherein said yoke is coupleable to a bumper-pull hitch.

12. The bi-fold trailer system of claim 1, wherein said yoke is coupleable to a fifth-wheel hitch.

13. The bi-fold trailer system of claim 1, wherein said yoke is coupleable to a goose-neck hitch.

14. The bi-fold trailer system of claim 1, wherein said extension is removable from said trailer-chassis.

15. The bi-fold trailer system of claim 1, wherein said extension is slidable within said trailer-chassis.

16. The bi-fold trailer system of claim 1, wherein said extension is rotatable upward in relation to said trailer-chassis.

17. A bi-fold trailer system, the bi-fold trailer system comprising:
a trailer-chassis, said trailer-chassis comprising a frame, an extension located on a front-end of said trailer-chassis, and a yoke;
at least two wheel assemblies rotatably coupled to said trailer-chassis;
a plurality of casters coupled to said trailer-chassis nearest at least at four corners of said trailer-chassis;
wherein said yoke is removably coupleable to said extension of said trailer-chassis on said front-end;
wherein said bi-fold trailer system is removably coupleable to a vehicle;
wherein said frame of said trailer-chassis includes a left-side-frame and a right-side-frame, with said left-side-frame and said right-side-frame hingedly coupled at a rear-end of said trailer-chassis such that said left-side-frame and said right-side-frame are rotatable outward from each other into an open position when removed from said vehicle;
wherein said trailer-chassis includes a tool-box assembly;
wherein said at least two wheel assemblies are rotatable via an air-bag system;
wherein said yoke is removable and replaceable via a yoke-pin;
wherein said at least two wheel assemblies include an air-bag suspension;
wherein said yoke is coupleable to a bumper-pull hitch; and
wherein said extension is slidable within said trailer-chassis.

18. The bi-fold trailer system of claim 17, further comprising set of instructions; and
wherein the system is arranged as a kit.

19. A method of using a bi-fold trailer system, the method comprising the steps of:
providing a bi-fold trailer system;
coupling said bi-fold trailer system to a vehicle;
moving said bi-fold trailer system via said vehicle;
decoupling said bi-fold trailer system from said vehicle;
removing a yoke from said bi-fold trailer system; and
expanding a left-side-frame and a right-side-frame of said bi-fold trailer system outward from each other.

20. The method of claim 19, further comprising the steps of:
contracting said left-side-frame and said right-side frame together;
replacing said yoke to said bi-fold trailer system; and
coupling said bi-fold trailer system to said vehicle, and alternatively, a second-vehicle.
